(19) United States
(12) Patent Application Publication
(10) Pub. No.: US 2006/0150848 A1
(43) Pub. Date: Jul. 13, 2006

(54) Personalization of printed items, especially subscription newspapers/magazines

(76) Inventor: Christoph Deutsch, Dresden (DE)

Correspondence Address: EDWARDS & ANGELL, LLP, P.O. BOX 55874, BOSTON, MA, 02205, US

(21) Appl. No.: 10/541,312

(22) PCT Filed: Jan. 2, 2004
(86) PCT No.: PCT/EP04/00010

§ 371 Date: Jul. 1, 2005

Related U.S. Application Data
(60) Provisional application No. 60/462,815, filed on Apr. 14, 2003.

(30) Foreign Application Priority Data
Jan. 3, 2003 (DE) 103 00 071.2

(51) Int. Cl. B41F 33/00

(52) U.S. Cl. 101/483

(57) ABSTRACT

In a method for the production of addressee-specific printed products wherein, for the completion of each printed product, a plurality of printed sheets (120a, 120b, 120c) are assembled for forming inner pages of the finished printed product, provided with a cover page and stapled or bound, an EDP-supported database structure, which allocates to a respective addressee of each printed product information characterising the addressee, is provided. At least one of the printed sheets (120a) becomes an addressee-specific printed sheet as a result of the attachment of addressee-specific information to at least one predetermined location. The printed products are provided after the completion for an addressee-specific delivery on the basis of information from the database structure and/or on the basis of the addressee-specific information on the personalised printed sheet (120a). A plurality of addressee-specific media (126), the format of which is different from that of the finished printed product, are produced using information from the database structure, each medium (126) containing characteristic information for a respective addressee, and, for the completion of the respective addressee-specific printed product, at least one of the plurality of addressee-specific media (126) is attached to the at least one addressee-specific printed sheet (120a).

The present invention relates to a method for producing personalised printed products and to a system for producing personalised printed products.

In printing and publishing, it is often desirable to distribute printed products that are produced in large print runs in a personalised form to addressees. Known examples of this include personalised advertising cards on which, in addition to the advertised product or the advertised service, the name and address of each addressee or the like is printed. Personalised advertising cards of this type are conventionally produced in a two-stage process wherein, in a first stage, anonymous advertising cards are firstly printed and the corresponding addressee-specific information is then imprinted prior to the dispatching of the advertising cards.

It is also known, in the sale of newspapers/magazines on a subscription basis or in the sale of catalogues or brochures, to provide personalisation that consists in the fact that, after production of the product, names and addresses of addressees are imprinted, and this substantially simplifies the dispatching of these products. Moreover, it is conventional not only to imprint the name and address on a product ready for dispatch, but also to enclose a personalised letter or a personalised invoice with such consignments during preparation for dispatch. According to US 2002/0046089 A1, an advertising brochure consisting of a plurality of pages is attached to the front or back cover page of a magazine. The content of the advertising brochure is tailored to the respective addressee of the magazine, wherein various brochures may be attached depending on whether or not the addressee belongs to various addressee groups. In this case, too, the address may simply be imprinted on the front page of the brochure.

In the case of a printed product consisting of individual printed sheets, for example a magazine or advertising brochure, it is known from DE 195 12 501 A1 to imprint, for the purposes of personalisation, some of the printed sheets with addressee-specific information, for example the value of a voucher, and then to assemble in a gatherer stitcher the personalised printed sheet, together with the additional anonymous printed sheets in the known manner, in order to form the magazine or brochure. In order, where possible, to detect allocation errors, which can occur very easily in this procedure, and to be able to act accordingly, feeders of the gatherer stitcher, which are provided for assembling the personalised printed sheets, are provided in this case with a lead feeder and a principal feeder connected downstream, between which the personalised printed sheets are conveyed in fanned-out form via a conveying path, so that a reading device may read out a marking attached to the personalised printed sheets, and the personalised sheets are identified during assembly. However, this method is complex in terms of equipment and logistics.

Recently, in the sale of newspapers and magazines, methods have been introduced by means of which, after the assembly of already printed individual pages or printed sheets to form the respective magazine, personalised information may be imprinted on a predetermined page of the magazine before the magazine is then prepared for dispatch. In other words, in these methods, a finished anonymous printed product is initially produced on which addressee-specific or personalised information is imprinted at a predetermined location prior to preparation for dispatch. The printed product becomes addressee-specific with the address details only shortly before the preparation for dispatch, generally between the operating steps to be carried out during assembly/stapling or packaging of the printed product, and therefore substantially in a single working process, so that the correct allocation of the addressee-specific information and respectively associated printed product does not cause any problems. These methods are substantially easier to implement and do not require excessive additional outlay, so they have proven more successful than the method indicated in DE 195 12 501 A1. However, they only allow addressee-specific information to be imprinted on printed sheets at predetermined locations.

The object of the present invention is to indicate a method and to provide a system by means of which addressee-specific information may be included in any manner and form, in particular as addressee-specific media attached to a printed product, in a printed product provided for a predetermined addressee.

In order to achieve the said object, the present invention provides, according to a first aspect, a method for the attachment of addressee-specific media to printed products, involving the steps:

a) provision of an EDP-supported database structure, which allocates to a respective addressee of a printed product information characterising the addressee;

b) production of a plurality of addressee-specific media using information from the database structure, each medium containing specific information for a respective addressee;

c) completion of addressee-specific printed products, each printed product being made addressee-specific at least in that an addressee-specific medium is attached to at least one provided location; and

d) provision of the printed products for an addressee-specific delivery on the basis of information from the database structure and/or on the basis of information contained in an addressee-specific medium.

In this case, it is beneficial if, for the completion of each printed product, a plurality of printed sheets are assembled for forming inner pages of the finished printed product, provided with a cover page and stapled or bound and, for the completion of the respective addressee-specific printed product, at least one of the plurality of addressee-specific media is attached to at least one printed sheet, a plurality of addressee-specific media preferably being attached to the printed product and the format of the addressee-specific media being different from that of the printed product.

In order to achieve the said object, the present invention provides, according to a second aspect, a method for producing addressee-specific printed products wherein, for the completion of each printed product, a plurality of printed sheets are assembled for forming inner pages of the finished printed product, provided with a cover page and stapled or bound, an EDP-supported database structure, which allocates to the respective addressee of each printed product information characterising the addressee, being provided, at least one of the printed sheets becoming an addressee-specific printed sheet as a result of the attachment of addressee-specific information to at least one predetermined location, the printed products being provided after the completion for an addressee-specific delivery on the basis of information from the database structure and/or on the basis of the addressee-specific information on the personalised printed sheet, characterised in that a plurality of addressee-specific media, the format of which is different from that of the finished printed product, are produced using information from the database structure, each medium containing characteristic information for a respective addressee, and in that, for the completion of the respective addressee-specific printed product, at least one of the plurality of addressee-specific media is attached to the at least one addressee-specific printed sheet, a plurality of addressee-specific media preferably being attached to the printed product.

According to the method of the invention, it is provided, on the basis of the information provided in the database structure, on the one hand to produce the respective addressee-specific media and on the other hand to carry out production of the printed products such that the addressee-specific media may be attached and the printed products completed. The printed products become, in this case, addressee-specific printed products at least as a result of the attachment of one of the already produced addressee-specific media to the printed product. The term “attachment”, in the sense in which it is used here, is intended to mean that the respective addressee-specific medium is added to a printed product in fixed association, for example glued on, stapled on or attached. It should be emphasised at this point that a respective printed product may, according to the present method, be addressee-specific even before the addressee-specific medium is attached, for example if a respective different printed product is specifically allocated to each addressee. In this case, therefore, an addressee-specific medium is attached to a printed product that is already addressee-specific, wherein care must be taken that the medium and printed product are associated with each other.

The invention allows, for example, one or more additional media personalised in the above-described manner to be enclosed in a printed product. For example, it would be conceivable to enclose postcards or even entire pull-outs, which are tailored quite specifically to the respective addressee, at an arbitrary point in a magazine, especially inside the magazine. In this case, it is necessary also to produce, in addition to the production of the printed product, which, despite already being provided for a specific addressee, is per se anonymous, the correspondingly provided addressee-specific media (i.e. postcards/pull-outs, etc.) and to enclose them in the printed product.

Examples of addressee-specific media of the relevant type include cards or postcards or discount coupons, which are affixed to corresponding advertisements, but also CDs attached in this manner or relatively small sample packages (for example, cosmetics). The media may also be addressee-specific in that they refer to products or services specific to the respective addressee (for example, addressee-specific promotional catalogues on CD-ROM).

The completion of the printed products generally includes a plurality of successive working processes, for example the printing of the individual sheets of a printed product, assembly of the sheets and then stapling of the printed product. According to the method of the invention, some of these working processes may, depending on the application, be carried out simultaneously to the production of the plurality of addressee-specific media.

During the production of printed products, for example magazines or catalogues, the individual sheets of each printed product are generally printed before one of these sheets is in each case assembled to form a finished printed product and the assembled sheets are then stapled and completed for dispatch. If the method according to the invention is used, it is also possible, depending on specific individual requirements, that, during completion of the printed product, the final assembly and stapling or binding of the finished printed product take place only after the attachment of an addressee-specific medium to a provided location in each of the printed products. In this case, a respective addressee-specific medium is, for example, attached to a printed sheet of a printed product provided for this purpose, preferably in direct connection to the printing thereof, and the addressee-specific printed sheets that are then produced are prepared in a specific sequence for the assembly of the respective addressee-specific printed product.

The method may, for example, be configured such that anonymous printed sheets of the respective printed product, with which sheets no addressee-specific medium is associated, are assembled in sequence up to and including a printed sheet to be made addressee-specific, with which an addressee-specific medium is associated. The addressee-specific medium associated with the printed sheet to be made addressee-specific/the addressee-specific media associated with the printed sheet are then attached to the printed sheet, and this is easily possible, as the printed sheet is now located right at the outside or right on top of the stack of printed sheets to be assembled. The further printed sheets of the respective printed product are then assembled, the aforementioned steps optionally being repeated if still further printed sheets, with which addressee-specific media are associated, are contained in the respective printed product.

In another variant of the method, the addressee-specific medium associated with each printed sheet to be made addressee-specific/the addressee-specific media associated with each printed sheet are attached to the printed sheet to be made addressee-specific, and this may take place, for example, in direct conjunction with the production of the respective addressee-specific medium, as the corresponding printed sheet is then generally not yet associated with any of the addressees. It is clear that this step may optionally be carried out for all of the printed sheets with which addressee-specific media are associated. All of the printed sheets of the respective printed product are then assembled in sequence, for example on a known collecting path, including the printed sheet/printed sheets to which addressee-specific media are attached. In this case, care must above all be taken that the respective addressee-specific printed sheets assembled for a printed product also contain addressee-specific media associated with the corresponding addressee. The advantage of this method variant is a slightly greater degree of flexibility than in the aforementioned method variant; nevertheless, it may beneficially be used only if it can be ensured that a further reliable assembly (for example, via a corresponding feeder) is also possible using addressee-specific media attached to the printed sheet, i.e. that errors occur only infrequently. This will generally be the case with media that do not differ greatly from the format and type of the printed sheets.

On the other hand, however, it is also conceivable that, during completion of each addressee-specific printed product, at least the final assembly of a finished printed product takes place before an addressee-specific medium is attached. In this case, the sheets of a printed product are therefore initially assembled to form a printed product, which is still anonymous, and only then is an addressee-specific medium attached to a corresponding sheet of this printed product, thus rendering the printed product addressee-specific. This procedure has the advantage that there are fewer steps between the ascertainment of the addressee for a printed product and the completion of this printed product for dispatch than in the two aforementioned method variants, so fewer errors are accordingly to be expected. This procedure is also that which is most compatible with the methods known from the prior art. This method may, of course, be applied only if an already assembled printed product may again be “opened” sufficiently far that the respective addressee-specific medium may be attached.

It is beneficial if the completion of each addressee-specific printed product and the production of the addressee-specific media are coordinated with each other such that the sequence of the production of addressee-specific media corresponds to the sequence in which the addressee-specific printed products are completed, as correct association of the addressee-specific media and the corresponding printed products is then ensured in a relatively simple manner. In this case, the printed products for an addressee-specified delivery may be prepared on the basis of information from the database structure, on the basis of which the sequence of the production of the corresponding addressee-specified media and the completion of the corresponding addressee-specified printed products has already been established.

However, given the corresponding complexity of the processes to be coordinated for the production of addressee-specific media and of printed products, as well as the subsequent preparation for dispatch, erroneous associations are to be expected with a relatively high degree of probability. In order to prevent defective addressee-specific printed products from being prepared in this case for dispatch, it is preferably provided that, additionally or alternatively, the printed products are prepared for an addressee-specific delivery on the basis of information contained in an addressee-specific medium. The addressee-specific information of a medium to be found on a printed product that is currently to be prepared for dispatch may thus, for example, be used to present further important information for dispatching the printed product (for example, the dispatch address or a corresponding invoice) or the actually detected addressee-specific information may be compared with the corresponding information derived from the database structure, so erroneous associations may easily be detected.

Once an addressee-specific printed product has been substantially completed, the printed product for an addressee-specific delivery may be prepared relatively directly using methods known in printing and publishing, so erroneous associations should at this stage occur only infrequently. However, this is not the case if the addressee-specific media, after the production thereof, are respectively to be allocated to a provided printed product. For this reason, it is beneficial if the completion of each addressee-specific printed product also involves reading out and saving a machine-readable marking of an addressee-specific medium in association with the attachment of the addressee-specific medium to a printed product: the saved machine-readable marking may then be used for the further processing of the printed product, which by now has become addressee-specific. If erroneous associations between a printed product and an addressee-specific medium have occurred prior to this point, it may be ensured, by reading out and saving the actual machine-readable marking of an addressee-specific medium, that the error is detected and/or that a dispatch address or invoice associated with the respective medium is nevertheless subsequently attached.

In view of the fact that precise establishment of the positioning of a marking is not possible owing to the nature and formats, which may vary markedly, of different addressee-specific media amongst themselves and of the addressee-specific media and the respective printed product and the free arrangement of an addressee-specific medium on a printed sheet, this additional measure would appear to be excessive, for high-performance and flexible reading devices have to be used. Nevertheless, it has been found that specifically as a result of the machine-readable marking an extremely low error rate may be achieved, and this ultimately justifies the increased outlay.

In the event of the machine-readable marking being read out and saved during the completion of each printed product, it may also be provided that the production of the addressee-specific media also involves attachment of the machine-readable marking to each medium. In this case, the marking is attached such that the addressee associated with the medium may be determined by means of the machine-readable marking. It is thus ensured that each of the addressee-specific media is given, in direct association with the production thereof, a corresponding machine-readable marking, preferably immediately after the medium has been produced.

It may be provided that, for the provision for an addressee-specific delivery, additional addressee-specific information is attached to the substantially finished printed product on the basis of the saved marking of the at least one addressee-specific medium contained in the printed product and/or on the basis of information from the database structure. As has already been mentioned, this additional addressee-specific information may, in particular, include a dispatch address for the predetermined addressee or a corresponding enclosed invoice and the like. In accordance with the foregoing explanations, the saved marking may be used for extracting such information. Additionally or alternatively, the database structure may also be utilised in this case.

It is also preferably provided that the machine-readable marking is read out optically. Tried and tested methods are available for this purpose in the printing/publishing/dispatch field, for example for the sorting of letters. In particular, it may be provided that, for producing the machine-readable marking, a text in a machine-readable font, preferably an OCR font, is attached to the medium. A text of this type may, for example, be the name and/or the address of an addressee, which in many cases has to be imprinted anyway. A machine-readable font is used so that the text may be identified unambiguously. OCR fonts, for example, have proven to be reliable in the prior art. Obviously, the machine-readable text may also be attached to the medium in addition to the actual text to be imprinted, for example if the name/address is to be printed in a non-machine-readable font.

A method in which a machine-readable marking may be attached to a medium in an especially error-proof manner consists in the fact that the machine-readable marking is attached to the medium in the form of a bar code. Such bar codes are used in the art in a wide variety of ways. They are distinguished above all in that only very low error rates occur in detection of the marking using corresponding bar code scanners.

The addressee-specific printed products are generally produced in a predetermined sequence, which is determined by corresponding logistical requirements, such as the order of the delivery routes or the combination of various address regions to form common units to be delivered. In such cases, it is then advantageous if the associated addressee-specific media are produced in a corresponding sequence or are placed in such a sequence after production. The advantage of a procedure of this kind consists in the fact that, for allocating each addressee-specific medium to the printed product associated therewith, the two “stacks” have merely to be processed in the predetermined sequence.

If a machine-readable marking is used, it may be provided that the machine-readable marking is associated with an operating data record number, which in each case is continuously assigned to a printed product to be dispatched to a specific addressee. The number is expediently assigned in the predetermined sequence in which the printed products are to be produced. This procedure allows the printed products to be produced to be placed in a beneficial sequence for dispatch even before the production of the printed products and the addressee-specific media. This sequence then determines the operating data record number, by means of which the allocation of a machine-readable marker detected at some later point to a data record is directly possible.

If a predetermined sequence in which the addressee-specific printed products are to be produced is established, it may advantageously be provided that the sequence of the read markings is compared to the predetermined sequence and on detection of discrepancies, corresponding corrective measures are carried out. If, therefore, an erroneous association occurs, for example because a wrong address label was attached to an addressee-specific printed product or because an addressee-specific medium that was intended to be associated with a different printed product was attached to one of the printed products, the respective printed products may be removed as soon as possible, and in any case prior to dispatch of the completed printed products, from the course of production and a new production of the corresponding defective printed product, optionally without the addressee-specific medium and with only the imprinted address, instigated (after-print). On introduction of a plurality of different addressee-specific media, it is conceivable to replace with “anonymous” pages only those pages containing defective addressee-specific media. Correspondingly programmed error scenarios may be provided for this purpose. In particular, it may be provided directly to check the correct attachment of each addressee-specific medium. However, a deviation of the finished printed products from the predetermined sequence may also be corrected by instigating a corresponding re-sorting prior to the final preparation for dispatch.

In the method according to the invention, it is also preferably provided that during the production of the addressee-specific media, respective items of static information, which are identical for a large number of media, are processed and/or applied separately from items of dynamic information, which are different for each medium. In this case, it is provided, in particular, that two supplementary prints are used for producing each addressee-specific medium, a first print, which is identical for all of the addressee-specific media, being used for printing the static information. A second print, which is to be produced for each medium, is used, on the other hand, for printing the dynamic information.

The aim of this separation of variable data (for example, name and address) and non-variable data (for example, the layout of an advertisement) is an, at times substantial, reduction in the amount of data produced with large print runs, as the non-variable data sets often comprise a much larger amount of data than the variable data sets of an addressee-specific medium. The respective record documents for the non-variable data or the variable data may be produced using conventional, preferably computer-assisted, methods.

In order to increase the efficiency of the production of the addressee-specific media, it may be provided that a plurality of media are produced per operating step, the media being produced in a sequence in which as many media as possible per operating step are produced simultaneously. In particular, it may be provided that the media, during the production thereof, are placed temporarily in a different sequence from the predetermined sequence. This may be necessary, for example, in order always to be able to utilise the maximum possible proportion of the surface of a printed sheet in the case of printed media (postcards). After completion, the media are then optionally placed back in the predetermined sequence, in order to allow the further operating steps to be carried out as described above.

The method of the present invention allows a large number of different media to be used as addressee-specific media, for example relatively small-format printed products, preferably cards, postcards or coupons (for example, discount coupons), on which at least the name of the addressee is imprinted. However, it is also entirely conceivable to use CDs, sample packages (for example, perfumes, creams or the like), textiles, etc. as the addressee-specific media. The printed products are, above all, stapled or adhesive-bound magazines or other brochures.

According to the first aspect of the present invention, for carrying out the method, a system is proposed for producing printed products containing addressee-specific media, in particular by one of the above-described methods, the system comprising an EDP-supported database having a database structure, which allocates to a respective addressee of a printed product information characterising the addressee, a media production unit for producing addressee-specific media, each medium containing specific information for a respective addressee, a printed product production unit for printing, assembling and stapling the respective printed product, which comprises a media attachment unit for the attachment of a respective medium to at least one provided location of the printed product, and a dispatching unit for preparing each substantially finished printed product for dispatch, wherein the dispatching unit and the printed product production unit and optionally also the media production unit may be operated in coordination with one another such that the printed products, which are respectively turned into an addressee-specific printed product by means of at least one addressee-specific medium, may be provided for addressee-specific delivery.

Advantageously, the system is configured such that the printed product production unit is configured for printing a cover page of each finished printed product and a plurality of printed sheets forming inner pages of the finished printed product, assembly of the cover page and the plurality of printed sheets and stapling or binding of the plurality of printed sheets including the cover page, wherein addressee-specific information may be attached to at least one of the printed sheets, the addressee-specific printed sheet, at at least one predetermined location, the media production unit being configured for the production of addressee-specific media, the format of which differs from the format of the respective printed product, and the media attachment unit being configured for the attachment of at least one of the plurality of addressee-specific media to the at least one addressee-specific printed sheet, wherein a plurality of addressee-specific media may preferably be attached to the respective printed product.

According to the second aspect of the present invention, for carrying out the described method, a system is provided for the production of addressee-specific printed products. The system comprises an EDP-supported database having a database structure, which allocates to a respective addressee of a printed product information characterising the addressee, a printed product production unit for printing a cover page of each finished printed product and a plurality of printed sheets forming inner pages of the finished printed product, assembly of the cover page and the plurality of printed sheets and stapling or binding of the plurality of printed sheets including the cover page, wherein addressee-specific information may be attached to at least one of the printed sheets, the addressee-specific printed sheet, at at least one predetermined location, and a dispatching unit for preparing each substantially finished printed product for dispatch. The system also comprises at least one media production unit for the production of a plurality of addressee-specific media, the format of which differs from the format of the respective printed product, each medium containing specific information for an addressee. The printed product production unit comprises at least one media attachment unit for attachment of at least one of the plurality of addressee-specific media to the at least one addressee-specific printed sheet, wherein a plurality of addressee-specific media may preferably be attached to the respective printed product. The dispatching unit, the printed product production unit and the media production unit may be operated in coordination with one another such that the printed products, which are made addressee-specific printed products by means of at least one addressee-specific medium, may be provided for addressee-specific delivery.

The printed product production unit may, for example, comprise a gatherer stitcher comprising a plurality of feeders for assembling individual printed sheets of the respective printed product, a media attachment unit being connected upstream of each feeder provided for assembling the addressee-specific printed sheet (with which the addressee-specific medium/addressee-specific media are associated). In this configuration, the known arrangement of a gatherer stitcher may be used, so existing equipment may be converted comparatively easily. The additional media attachment unit has merely to be connected upstream of the respective feeder provided for the addressee-specific sheet or the respective conventional feeder to be replaced by a feeder that has the additional media attachment function. However, it is necessary that the feeder also operates reliably with the printed sheets provided with the addressee-specific medium. This may be problematic in the case of relatively bulky media, for example thick cartons, brochures or CDs.

Alternatively, it may be provided that the printed product production unit comprises a gatherer stitcher comprising a plurality of feeders for assembling individual printed sheets of the respective printed product, the media attachment unit being connected downstream of the feeders. In this case, too, the gatherer stitcher does not have to be converted; a media attachment unit has merely to be additionally inserted in the working path between the feeders and the stapling or binding station. In this case, there is even greater flexibility than in the previously described case, as addressee-specific media may be attached on each page of the printed product using a single media attachment unit. However, as it is necessary, in the case of a printed product that has already been assembled, to fan out the pages subsequently, this method is suitable primarily if small, flat and easy-to-handle (for example, correspondingly pliable) media such as coupons are to be attached.

It is also possible that the printed product production unit comprises a gatherer stitcher with a plurality of feeders for assembling individual printed sheets of the respective printed product, a respective media attachment unit being connected immediately downstream of a feeder provided for assembling a printed sheet to be made addressee-specific using an addressee-specific medium/addressee-specific media. In this case, an individual media attachment unit, which is also arranged in the working path of the printed sheets between the feeders, is required for each printed sheet to be made addressee-specific. This variant is therefore accordingly elaborate, though it has the advantage that even complex media may easily be attached to the outermost or uppermost printed sheet.

An information detection unit, which is configured for detecting information contained in the media, by means of which the addressee associated with the medium may be determined, is preferably associated with the media attachment unit. In this case, the information detection unit may be integrated directly into the media attachment unit. Alternatively, it is also conceivable to position the information detection unit upstream or downstream of the media attachment unit, although in this case it is important to ensure that the addressee-specific information contained in the medium is detected in fixed association with the attachment of the medium.

The information detection unit may comprise, in addition to a sensor for detecting at least a portion of the addressee-specific information in the medium, a memory in order to save the detected addressee-specific information. On the basis of this stored information, the addressee associated with the corresponding printed product may then subsequently be determined at any time, so that additional addressee-specific information, for example address labels, may accordingly be attached to the printed product.

For producing the information in the respective addressee-specific media, by means of which the addressee associated with the medium may be determined, it is preferably provided that a correspondingly configured information transmission unit is associated with the media production unit. This information transmission unit ensures, in direct association with the production of an addressee-specific medium, that a corresponding, preferably machine-readable marking is attached to this medium.

The information detection unit and the information transmission unit are preferably devices configured for the optical detection or transmission of signals, in particular an OCR font scanner or OCR font printer or a bar code scanner or bar code printer. Both types of systems are well known and have been sufficiently tested in the prior art. The system according to the invention may, for example, comprise a media production unit that is configured for the production of relatively small-format printed products, preferably cards, postcards or coupons (for example, discount coupons). The media attachment unit is then accordingly configured for the attachment of postcards or relatively small-format printed products, preferably cards, postcards or coupons (for example, discount coupons), to printed products. It should be emphasised once more at this point that this is merely one possibility out of a large number of other conceivable variants; for example, the media production unit and media attachment unit may be configured for the production and for the attachment of CDs, textiles, sample packages and the like.

The system is preferably configured for the production of stapled or adhesive-bound magazines or brochures.

The invention will be descried below in detail with reference to a preferred embodiment. In the drawings:

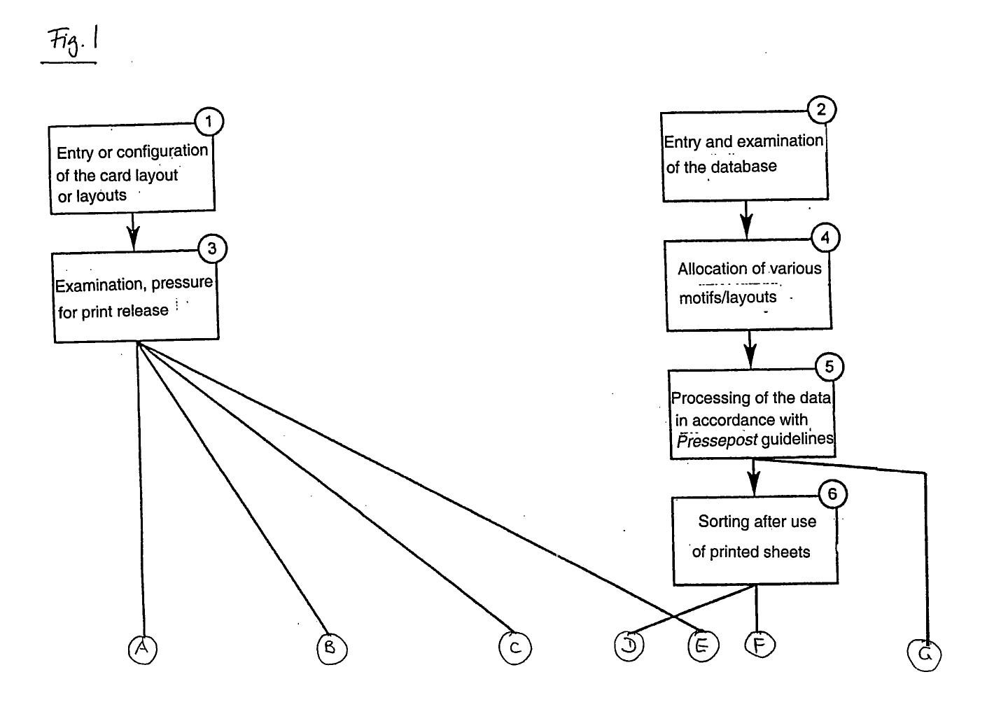

FIG. 1 is a flow chart for illustrating the first steps in the course of production in the production of printed products, to which addressee-specific media are attached by the method according to the invention;

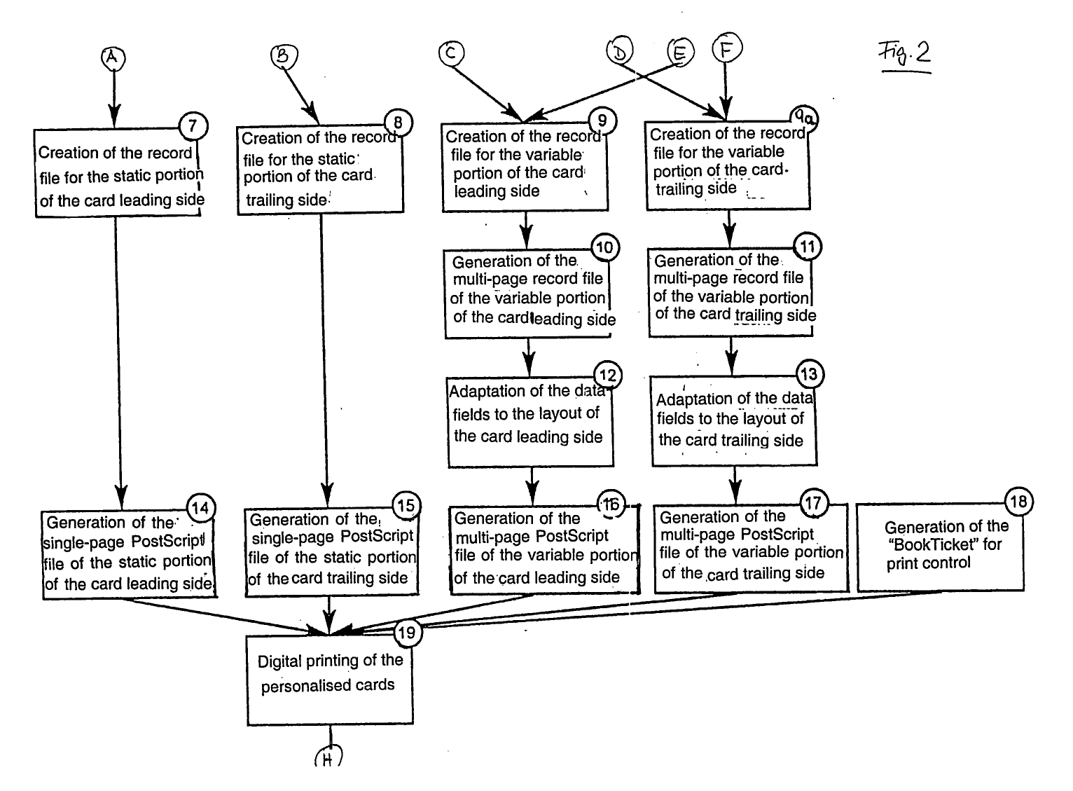

FIG. 2 shows the continuation of the course of production shown in FIG. 1;

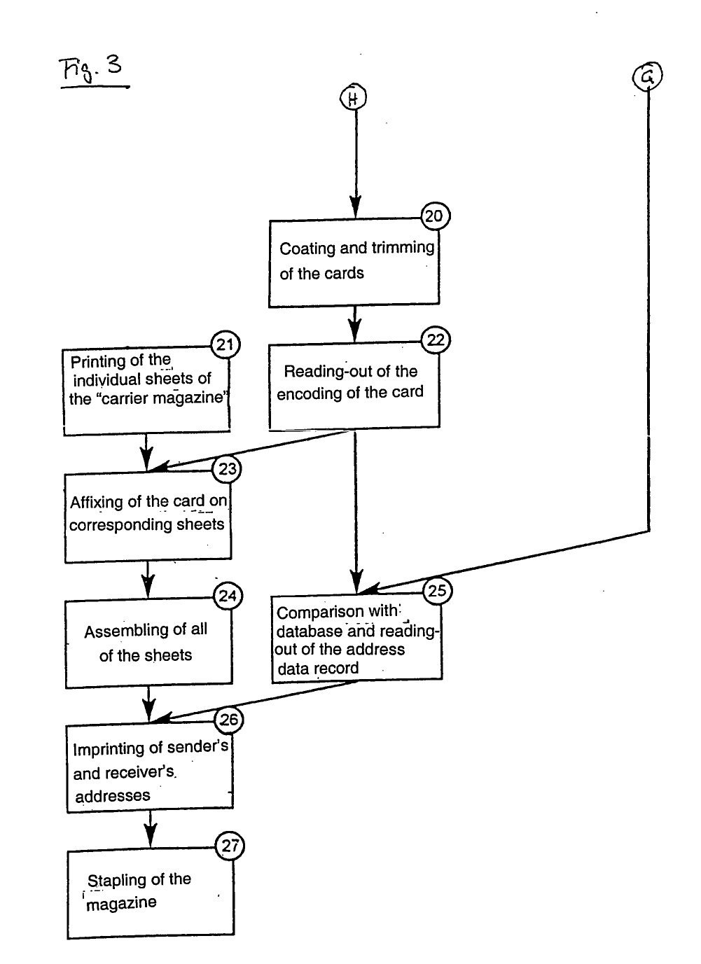

FIG. 3 shows the continuation of the course of production shown in FIG. 2; and

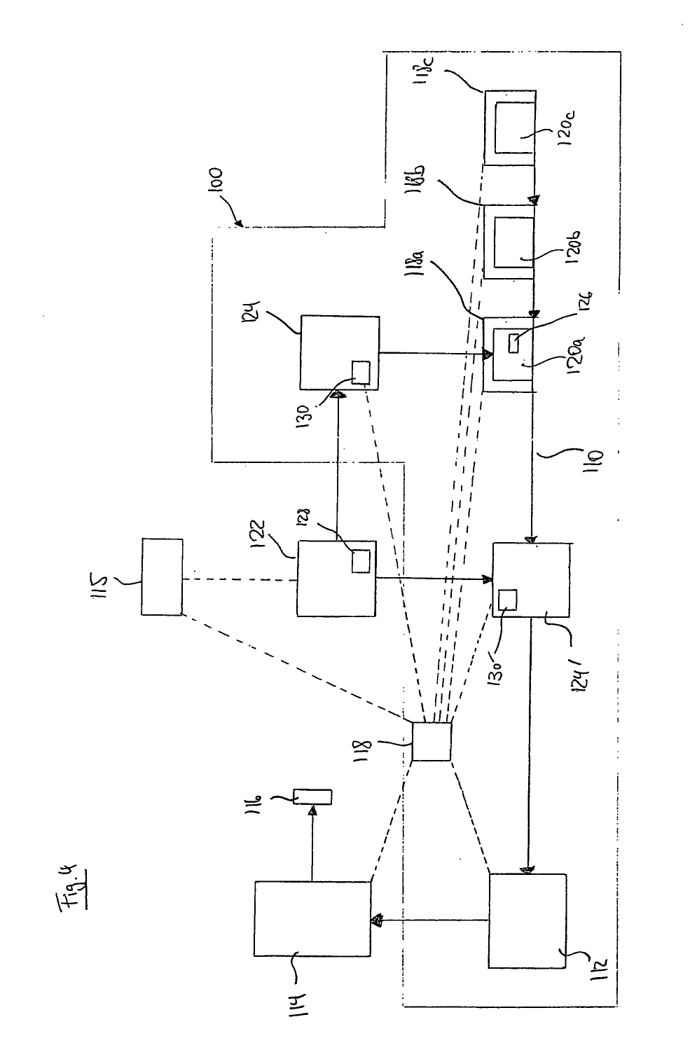

FIG. 4 is a schematic block diagram of a system for the production of printed products with addressee-specific media attached thereto, which system is provided for carrying out the method according to the invention.

Personalised printed products, especially magazines sold on a subscription basis, are intended to be produced by means of the method according to the invention. A (post)card or discount coupon personalised for a respective known subscriber is glued to a pre-produced advertisement, which is imprinted in a magazine to which the respective subscriber subscribes. Care must be taken in the production of the magazine that the personalised card is attached in the magazine in accordance with the subsequent dispatch address, so each subscriber receives the newspaper/magazine addressed to him, with the card including the advertising message personally geared toward him.

FIGS. 1 to 3 show, in the form of a flow chart, the plan for the course of production in the production, by the method according to the invention, of such magazines sold on a subscription basis. Cards containing information that is personalised for each subscriber, i.e. addressee-specific information (what is known as “Direct AD™”), are glued into the magazines. A fundamental advantage of Direct ADs is the personal addressing of the reader, which allows a “dialogue” between the reader and the advertiser. Further advantages include the targeted delivery, as it is generally the readers who pay for their magazines and therefore ensure that their saved personal data is kept up to date. There are also benefits in terms of expenditure, as savings may be made on the postage costs for the advertising.

A prerequisite for the personal addressing of an individual magazine customer via personalised advertising messages by means of the Direct ADs™ is a customer database. A customer database of this type is generally provided by the publisher of a subscription magazine and contains, in addition to the subscriber's address information, as many additional addressee-specific details as possible, for example regarding the reading behaviour of the respective addressee, from which personal messages may be generated for the advertising medium. The database thus provides a specific “addressee profile” for each addressee.

Once this database has been entered (step 2 in FIG. 1), the database is initially subjected to an examination. In this, it is checked, on the one hand, whether the data received via any conventional data transmission method (for example, ISDN, FTP, CD, etc.) has a conventional data format (for example, dBase, Excel, text file) or whether the data may at least be converted into one of the conventional database file formats. On the other hand, it is also checked whether all of the data records are complete and whether the necessary data fields are provided. This operating step generally takes place individually, as required.

After that, in step 4, various layout motifs of the advertisement are allocated to each customer. Different advertising messages may be allocated to the customer for advertising a specific company, depending on the magazine and information from the addressee profile. If necessary, the corresponding addressing control may be generated in this operating step using the addressee profile. Further data fields are created, as required, on the basis of the data fields provided in the customer database using database commands known per se, and the motif name to be used or the personal addressing of the customer is, for example, placed in these further data fields.

The data records generated in step 4 are subsequently further processed in step 5 in the sense of an optimumly efficient delivery. This processing includes, primarily, a sorting of the data records according to the guidelines of the Deutsche Post AG Zentrale Bundfertigung (ZEBU) delivery service, in order to adapt the production sequence of the printed products to the logistical requirements (for example, the order of the Deutsche Post AG delivery routes). The processing is software-assisted, for example by the “ICOM Infopress” software. In this operating step, simultaneously to the processing, the packet labelling and pallet labelling slips required for marking the magazines to be packaged, following production, in accordance with the aforementioned regulations are printed, also assisted by the “ICOM Infopress” software.

Subsequently, in step 6, the data records are temporarily re-sorted again in order to achieve optimum utilisation of the printed sheets during the digital printing process of the cards containing the personalised advertising messages: it is generally necessary, for cost reasons, in the production of the cards containing the personalised advertising messages to print a plurality of different personalised cards for each printed sheet. The data structure, i.e., in particular, the sequence in which the cards are to be printed, is therefore adapted to the sequence required as a function of the final format and planned further processing, in the sense of an optimumly efficient utilisation of an individual printed sheet. This operating step preferably takes place such that new data fields, which are identical in terms of structure with the processed customer database, are created as a result of database commands and the corresponding portions of the customer database are transferred into this database, which is known as the “print database”. Subsequently, each new data record of this database processed for printing is thus filed with the data, which is re-sorted in accordance with an optimised utilisation of individual printed sheets, of the customer database. Once the processing, i.e. printing, coating and cutting of the cards, has been completed, the sequence of the cards, which now contain addressee-specific information, is re-sorted to the sequence established in step 5.

Graphics data relating to the configuration of the card layout or layouts is also necessary for the production of a card containing a specific advertising message. This graphics data may be received by the respective advertisement customer in a corresponding manner to the database or the publisher/the printer may design its own configurations (see step 1). A layout of this type generally contains merely a sample text or a wildcard at the location at which addressee-specific information is intended to appear later in the individual cards. In step 3, after one or more test prints of the card layout, said layout is examined by the publisher and the advertisement customer and released for printing.

The actual production, shown in FIG. 2, of the advertising cards containing addressee-specific information may then be carried out. For the portion of the data that is merely static, i.e. that is identical for all of the advertising cards to be printed, a record file is created separately for the front and back sides of the card (steps 7 and 8). In this case, too, care must be taken that the number, sequence and arrangement of cards printed for each sheet takes place in the optimum sequence in accordance with the print database produced in step 6. As all of the cards contain the same graphics and text elements, a merely single-page record file, which may be used for all of the printed sheets, is in this case required for the front and back sides of the card. A corresponding PostScript file for the digital print is produced from this single-page record file in steps 14 and 15 for the card front and back sides respectively of a printed sheet.

During the processing of the variable data extracted from the customer database (i.e. data that is addressee-specific and that therefore differs from card to card), a respective record document is also created, on the basis of the print database produced in step 6 and the layout specifications for the advertisement customer (for example, the font), for the front side (step 9) and for the back side (step 10) of the cards of a respective printed sheet with the optimum number, sequence and arrangement of individual cards determined in step 6. These record documents produced in steps 9 and 10 contain exclusively variable data. As the variable data sets are different for each of the addressee-specific cards, an individual record document must of course also be created for each printed sheet to be printed. As a result of the separation of variable and non-variable data, an, in most cases substantial, reduction in the large amounts of data, which are produced, in particular, as a result of the large print runs, may be achieved and the entire course of production thus optimised.

The processes described here may be carried out using conventional layout programs; the layout program “Quark-XPress” (Version 4.1 for Macintosh) is preferably used for this purpose in conjunction with the Xtension for Quark Xpress “Meadows Information Systems—Design Merge Pro” (Version 4.18) in order to assign the individual variable fields of the respective record file to the respective data fields of the print database.

In process steps 10 and 11, a multi-page record document is produced in each case for the front and back sides from the single-page documents linked to the print database using the program Design Merge Pro. Each page of this multi-page record document corresponds to a printed sheet and contains in each case the information of the data records of the print database.

In steps 12 and 13, a software-assisted examination and adaptation of the variable data to the text fields determined by the layout of the card takes place for each of the addressee-specific cards in a printed sheet. In this procedure, which takes place by means of Quark XPress Xtension “Meadows Information Systems—Copy Fit (Version 1.18)”, image data is automatically reduced or enlarged to the correct size and text fields adapted according to definable rules. Text data fields, the content of which is too large for the defined text frame, are preferably gradually adapted to the layout by gradual reduction of the font size and spacing. Similarly, an adaptation of varying image data fields to the underlying image frame is also possible.

In steps 16 and 17, the two multi-page record files are subsequently converted into PostScript, which is the page description language of the digital printing machine used in this case, via standard printer drivers.

In steps 18 and 19, the cards containing addressee-specific information are printed in a media production unit. This may take place using, for example, an IBM Infocolor 70 colour laser printer or preferably using a “MAN Roland DICO-Press 500” digital printing machine. What is known as a “BookTicket” is produced for connecting the mutually associated PostScript files containing variable and static information, respectively. This may be done manually, for example, using an editor according to the defined syntax of the manufacturer. The BookTicket provides the Barco PrintStreamer, which is positioned upstream of the printing machine, with all of the necessary information with respect to the printing or imprinting of the variable information. Following the printing process, the motif side of a card is generally coated with a UV varnish (step 20, see FIG. 3). As has already been stated, the produced cards are then cut out of the respective printed sheets, trimmed and sorted in the dispatch sequence of the carrier magazines (determined in step 6).

For further processing of the addressee-specific cards according to the present method, it is important that, for each individual addressee-specific card, a machine-readable encoding of this card must take place preferably during production of the record file for a respective printed sheet, optionally after the production of the multi-page record file for all of the printed sheets or after production of the cards. This machine-readable encoding of the individual addressee-specific card takes place in that an operating number of the data record on which the card is based is allocated to each card and a text, i.e. a character string unambiguously identifying the respective card, is provided on the card in a machine-readable font. The data record, which is linked to the data record number, of the print database or the customer database may thus easily be determined later, via the data record number, by detecting the machine-readable encoding of an addressee-specific card.

If non-machine-readable fonts (for example, scripts) are used as the text to be attached to the card, the unambiguous operating data record number is inserted into the record document of the variable data for the advertising postcard at the corresponding location on the front side. This may be done, for example, in a machine-readable OCR font or using a bar code.

Simultaneously to the processes described here for the production of the cards containing addressee-specific information, the individual sheets of the “carrier magazine” are printed in a manner known per se (FIG. 3, step 21). In order to attach a card containing addressee-specific information to the location respectively associated with said card, in the carrier magazine associated therewith, the encoding (for example, the data record number), which is preferably imprinted on the card as an OCR font, is first of all read out in step 22. The encoding is read out by a camera, which is provided on the “Heidelberger Druckmaschinen AG WK 400 card affixer”, which is preferably used in this case for affixing the cards. (Alternatively, a “Müller Martini 315 card affixer”, for example, could also be used.) This camera is connected directly to the control software of the “Heidelberger Druckmaschinen AG ST 400 gatherer stitcher”, which is preferably used for the stapling and direct addressing of the printed products (alternatively, a “Müller Martini Prima SB” gatherer stitcher could also be used), the card affixer also being integrated into the gatherer stitcher in this case. The individual card, which is associated in each case with a printed product to be assembled, in the card affixer is affixed to the corresponding location on the sheet provided for this purpose even before the assembly and stapling of the complete magazine. The font recognition, i.e. the reading-out and saving of the machine-readable marking contained in the addressee-specific card, takes place simultaneously by means of the control software of the gatherer stitcher. On the basis of this machine-readable marking, a comparison is then carried out with the customer database, which is sorted in the dispatch order (step 25). On the basis of this comparison, further data, for example the sender's and receiver's addresses, is determined from the database (customer database or print database).

Once the addressee-specific message has been attached to the card, all of the sheets of the “carrier magazine” are assembled in the gatherer stitcher (step 24). The addresses of the sender and receiver of the magazine are subsequently imprinted in step 26, during preparation of the printed product for dispatch, on the basis of the comparison carried out in step 25. This operating process takes place in the gatherer stitcher by the conventional known inkjet printing process, using commercially available inkjet print heads, and is controlled by the software of the gatherer stitcher. The stapling of the magazine subsequently also takes place in the gatherer stitcher.

If, in step 25 and/or during a subsequent read-after-write check shortly before the preparation of finished printed products for dispatch, erroneously ordered or missing addressee-specific media are detected in a printed product, an error log, which is used following production as a basis for necessary corrections, for example optional after-prints or manual re-sorting of individual magazines, is generated.

If three different addressee-specific media are to be attached to different pages of a printed product, the following error scenario may, for example, be pre-programmed. The fundamental aim of this scenario is to ensure that only addressee-specific media provided for a specific addressee are actually delivered and defective pages are replaced by non-personalised pages. This should allow at least two of three addressee-specific media to be glued into the printed product at the correct location.

If it is noted that the addressee-specific media are, at least in part, wrongly sorted, the course of production is halted and the addressee-specific media re-sorted in an extra machine. At the same time, while production is halted, the cause of the error is sought and eliminated off-line.

If one of the addressee-specific media is not removed, prior to attachment, from its correspondingly provided magazine, a non-personalised printed product is printed provided that the error occurred in the first addressee-specific medium. The error is subsequently eliminated in the first magazine. The address software receives an instruction to register a “buffer”, i.e. not to imprint an address on the non-personalised printed product. The course of production is subsequently continued as normal. If the error does not occur until the second or third addressee-specific medium, the interposition of a non-personalised printed product is no longer possible and production is merely halted, the error eliminated in the corresponding magazine and production then continued, non-personalised pages being inserted in the following printed product instead of pages comprising addressee-specific media that have already been glued in.

If a plurality of addressee-specific media are removed simultaneously from one of the magazines, non-identical addresses would subsequently be allocated to a printed product. In this case, too, production is halted and the error eliminated in the respective magazine.

It is also conceivable that an error occurs only after an addressee-specific medium has been removed from its magazine, but does not stick to the printed product or falls off. In this case, production is not halted if at least two of three addressee-specific media per printed product have been correctly attached, as an error of this type does not affect the production of the following printed products. However, if less than two of three addressee-specific media are attached to a booklet, production is halted in order to search for the error.

Finally, it is conceivable that an error is noted, for example because an addressee-specific medium has been affixed at a wrong location, during the subsequent affixing of the addressee-specific medium actually provided for this location. If this occurs in the first addressee-specific medium to be attached, production is halted, the defective signature (or the relevant page) exchanged and production then continued. If this does not occur until the second addressee-specific medium, the defective signature, together with the first addressee-specific medium, which has already been attached thereto, is rejected and an immediate re-sorting using “good” signatures and the second and third addressee-specific media instigated. If the error occurs in the third addressee-specific medium, the defective signature is rejected with the first or second addressee-specific medium, as well as the third addressee-specific medium, which has not yet been affixed. The error is registered by software in the list of printed products without addressee-specific media to be re-sorted.

FIG. 4 is a schematic block diagram of a system for the production of printed products, which system is suitable for carrying out the described method. In the system shown in FIG. 4, individual printed sheets of a magazine to be produced are, as is known per se, assembled or combined in a printed product production unit 100 via a gathering chain 110 in order subsequently to be stapled together in a stapling unit 112 and then prepared for dispatch in a dispatching unit 114.

A further function of the dispatching unit 114 is to monitor the completed printed products, so that defective printed products may be discarded into an error pile 116 prior to dispatch. The individual printed sheets to be assembled are supplied to the gathering chain 110 via corresponding feeders, three of which are denoted, by way of example, in FIG. 4 with reference numerals 118a, 118b, 118c. The feeders 118a to 118c each comprise a pile of identical printed sheets 120a, 120b, 120c, of which one sheet is removed in each case during assembly and deposited onto the gathering chain 110. Control of the individual feeders 120a to 120c, the gathering chain 110, the stapling unit 112 and the dispatching unit 114 is performed by a corresponding control unit 118 (known as a “Selective Binding Controller”), which is connected to each of the aforementioned machines for exchanging data or control commands (broken lines in FIG. 4). In order, in preparation for dispatch, to be able also to imprint subscribers' names and addresses, for example in the dispatching unit 114, the control unit 118 is connected to a database system 115, in which a customer database is stored.

The system shown in FIG. 4 also comprises a unit 122 for the production of addressee-specific media 126. Postcards associated with a specific advertisement, for example, on which, in addition to the advertising information, an item of addressee-specific information, for example the subscriber's name, is imprinted, may be produced by means of the media production unit 122. These addressee-specific media 26 should be attached to the printed products such that the addressee-specific medium 126 respectively associated with each printed product associated with a specific subscriber is also attached to said printed product. The media production unit 122 is also connected to the EDP-supported database system 115 containing the customer database, in order to be able to retrieve the corresponding addressee-specific information, such as the sequence in which the media 126 are to be produced.

A media attachment unit 124, by means of which a respective addressee-specific medium 126 is attached to a printed sheet 120a provided for this purpose, is also associated with the printed product production unit 100 comprising the feeders 118a to 118c, the gathering chain 110, the stapling unit 112 and the control unit 118. After the addressee-specific medium 126 has been attached, the respective printed sheet 120a is then deposited on the corresponding feeder 118a, so that a pile of the sheets 120a, which are now addressee-specific, is produced in the predetermined order on the feeder 118a. An information detection unit 130, by means of which at least a portion of the addressee-specific information attached to the respective medium may be detected, is also associated with the media attachment unit 124, so that the data record, which is associated with the respective addressee-specific medium 126, of the customer database may be determined. This information is saved by the control unit 118, so all of the further operating steps take place on the basis of this information.

Additionally or alternatively to the media attachment unit 124, the media attachment unit 124′ may also be associated with the printed product production unit 100. The media attachment unit 124′ differs from the media attachment unit 124 in that an addressee-specific medium 126 is attached to each printed product only once the individual printed sheets of the printed product have been assembled to form a complete magazine, i.e. at a later point in time in the course of production of the printed product. In all other respects, the function of the media attachment unit 124′ corresponds to that of the media attachment unit 124; in particular, an information detection unit 130′ is also associated with the media attachment unit 124′.

An information transmission unit 128, by means of which an item of machine-readable information is transmitted to a respectively produced or to-be-produced addressee-specific medium 126, is accordingly associated with the media production unit 122. The addressee associated with the respective medium may be determined in a later operating step by reading out this item of machine-readable information.

1-33. (canceled)

34. Method for producing addressee-specific printed products wherein, for the completion of each printed product, a plurality of printed sheets are assembled for forming inner pages of the finished printed product, provided with a cover page and stapled or bound, an EDP-supported database structure, which allocates to the respective addressee of each printed product information characterizing the addressee, being provided, at least one of the printed sheets becoming an addressee-specific printed sheet as a result of the attachment of addressee-specific information to at least one predetermined location, the printed products being provided after the completion for an addressee-specific delivery on the basis of information from the database structure and/or on the basis of the addressee-specific information on the personalized printed sheet, a plurality of addressee-specific media, the format of which is different from that of the finished printed product, being produced using information from the database structure, each medium containing characteristic information for a respective addressee, wherein, for the completion of the respective addressee-specific printed product, at least one of the plurality of addressee-specific media is attached to the at least one addressee-specific printed sheet on an inner page of the printed product.

35. Method according to claim 34, wherein a plurality of addressee-specific media are attached to the printed product.

36. Method according to claim 34, wherein during completion of each addressee-specific printed product, the final assembly and stapling or binding of the finished printed product take place only after the attachment of an addressee-specific medium to a provided location in the printed product.

37. Method according to claim 36, wherein the completion of each printed product involves the following steps:
a) assembly of anonymous printed sheets of the respective printed product, with which sheets no addressee-specific medium is associated, in sequence up to and including a printed sheet to be made addressee-specific, with which an addressee-specific medium is associated;
b) attachment to the printed sheet to be made addressee-specific of the addressee-specific medium/media associated with the printed sheet to be made addressee-specific; and
c) assembly of the further printed sheets of the respective printed product, optionally with repetition of steps a) to b), until all of the printed sheets have been assembled.

38. Method according to claim 36, wherein the completion of each printed product includes the following steps:
a) attachment to the printed sheet to be made addressee-specific of the addressee-specific medium/media associated with the printed sheet to be made addressee-specific and optionally carrying-out of this step for all further printed sheets to be made addressee-specific, with which addressee-specific media are associated; and
b) assembly of all of the printed sheets of the respective printed product in sequence including the addressee-specific printed sheet/the addressee-specific printed sheets to which addressee-specific media are attached.

39. Method according to claim 34, wherein during completion of each addressee-specific printed product, at least the final assembly of the finished printed product takes place before an addressee-specific medium is attached.

40. Method according to claim 34, wherein the completion of each addressee-specific printed product also involves reading out and saving a machine-readable marking of an addressee-specific medium in association with the attachment of the addressee-specific medium to a printed product.

41. Method according to claim 40, wherein the production of the plurality of addressee-specific media also involves attachment of the machine-readable marking to each medium such that the addressee associated with the medium may be determined by means of the machine-readable marking.

42. Method according to claim 40, wherein the provision for an addressee-specific delivery also involves the attachment of additional addressee-specific information to the substantially finished printed product on the basis of the saved marking of the at least one addressee-specific medium contained in the printed product and/or on the basis of information from the database structure.

43. Method according to claim 40, wherein the machine-readable marking is read out optically.

44. Method according to claim 40, wherein for producing the machine-readable marking, a text in a machine-readable font, preferably in an OCR font, is attached to the medium.

45. Method according to claim 40, wherein for producing the machine-readable marking, a bar code is attached to the medium.

46. Method according to claim 34, wherein the addressee-specific printed products are produced in a predetermined sequence and the associated addressee-specific media are produced in a corresponding sequence or are placed in such a sequence after production.

47. Method according to claim 39, wherein the machine-readable marking is associated with an operating data record number, which in each case is continuously assigned, in the predetermined sequence in which the printed products are to be produced, to a printed product to be dispatched to a specific addressee.

48. Method according to claim 45, wherein the sequence of the read markings is compared to the predetermined sequence and on detection of discrepancies, corresponding corrective measures are carried out.

49. Method according to claim 34, wherein during the production of the addressee-specific media, respective items of static information, which are identical for a large number of media, are processed and/or applied separately from items of dynamic information, which are different for each medium.

50. Method according to claim 49, wherein two supplementary prints are used for producing each addressee-specific medium, including a first print, which is identical for all of the addressee-specific media, being used for printing the static information and a second print, which is produced or is to be produced for each medium, being used for printing the dynamic information.

51. Method according to claim 34, wherein the production of the addressee-specific media, a plurality of media are produced per operating step, the media being produced in a sequence in which optimum efficiency per operating step is achieved.

52. Method according to claim 51, wherein the media, during the production thereof, are placed temporarily in a different sequence from the predetermined sequence and are placed in the predetermined sequence after completion.

53. Method according to claim 34, wherein relatively small-format printed products, preferably cards, postcards or coupons, on which at least the name of the addressee is imprinted, are used as the addressee-specific media.

54. Method according to claim 34, wherein the printed products are stapled or adhesive-bound magazines or brochures.

55. System for the production of addressee-specific printed products, comprising an EDP-supported database having a database structure, which allocates to a respective addressee of a printed product information characterizing the addressee, a printed product production unit for printing a cover page of each finished printed product and a plurality of printed sheets forming inner pages of the finished printed product, assembly of the cover page and the plurality of printed sheets and stapling or binding of the plurality of printed sheets including the cover page, wherein addressee-specific information may be attached to at least one of the printed sheets, the addressee-specific printed sheet, at least one predetermined location, and a dispatching unit for preparing each substantially finished printed product for dispatch, at least one media production unit for the production of a plurality of addressee-specific media, the format of which differs from the format of the respective printed product, each medium containing specific information for an addressee, wherein the printed product production unit comprises at least one media attachment unit for attachment of at least one of the plurality of addressee-specific media to the at least one addressee-specific printed sheet on an inner page of the printed product, and in that the dispatching unit, the printed product production unit and the media production unit may be operated in coordination with one another such that the printed products, which are made addressee-specific printed products by means of at least one addressee-specific medium, may be provided for addressee-specific delivery.

56. System according to claim 55, wherein a plurality of addressee-specific media may be attached to the respective printed product.

57. System according to claim 55, wherein the printed product production unit comprises a gatherer stitcher comprising a plurality of feeders for assembling individual printed sheets of the respective printed product, a media attachment unit being connected upstream of each feeder provided for assembling the addressee-specific printed sheet.

58. System according to claim 55, wherein the printed product production unit comprises a gatherer stitcher comprising a plurality of feeders for assembling individual printed sheets of the respective printed product, the media attachment unit being connected downstream of the feeders.

59. System according to claim 55, wherein the printed product production unit comprises a gatherer stitcher comprising a plurality of feeders for assembling individual printed sheets of the respective printed product, a respective media attachment unit being connected immediately downstream of a feeder provided for assembling a printed sheet to be made addressee-specific using an addressee-specific medium/addressee-specific media.

60. System according to claim 55, wherein an information detection unit, which is configured for detecting information contained in the media, by means of which the addressee associated with the medium may be determined, is associated with the media attachment unit.

61. System for the production of printed products according to claim 55, wherein an information transmission unit, which is configured for transmitting to the media information, by means of which the addressee associated with the medium may be determined, is associated with the media production unit.

62. System according to claim 60, wherein the information detection unit or the information transmission unit optically detects or transmits detectable signals and is configured, in particular, as an OCR font scanner or OCR font printer or as a bar code scanner or bar code printer.

63. System for the production of printed products according to claim 55, wherein the media production unit is configured for the production of relatively small-format printed products, preferably cards, postcards or coupons, and the media attachment unit is configured for the attachment of relatively small-format printed products, preferably cards or postcards, to printed products.

64. System according to claim 55, wherein the system is configured for the production of stapled or adhesive-bound magazines or brochures.
